(19) United States
(12) Patent Application Publication
(10) Pub. No.: US 2014/0314532 A1
(43) Pub. Date: Oct. 23, 2014

(54) Van slideout and lift

(71) Applicant: Larry Alexander, Indianapolis, IN (US)

(72) Inventor: Larry Alexander, Indianapolis, IN (US)

(21) Appl. No.: 13/986,320

(22) Filed: Apr. 22, 2013

(51) Int. Cl. B66C 7/10

(52) U.S. Cl. CPC B66C 7/10
USPC 414/542; 414/812

(57) ABSTRACT

A system and method for loading and unloading a large or small van. The method includes providing two or three support units in the form of a generally upsidedown U-shape. The top of each support includes a tube with a slot in the bottom thereof. Inside this tube is another tube which carries a hoist. The second tube is pushed out via an electric actuator so that a load may be picked up by the hoist and loaded into a van.

### BACKGROUND AND OBJECTS OF THE INVENTION

The present invention is generally related to the van loading arts and, in particular, to a novel method of loading and unloading vans of either larger or smaller sizes.

Applicant's prior art patents such as Pat. No. 8,398,357 teach a fold out and lift type of crane which has been proven to be highly effective.

The present invention teaches a slideout and lift method which is also highly useful in the art.

The use of vans for transport of packages etc has become more prevalent in the art. For example, as of the Spring of 2013, New York City has ordered that the fleet of some 13,000 taxis be converted to vans.

Accordingly, it is an object of the present invention to demonstrate a crane or lift system and method of use which may be effectively used with both smaller and larger vans.

It is a further object of the invention to show a van lift and loading method which requires less floor space on the van for a more cost effective overall lift usage.

It is also an object of the invention to show a van crane or lift method which utilizes the simpler slide-out design in contrast to the more complex fold-out or rotating crane systems of the prior art. Such use reduces operating and repair costs and is thus a major advantage in the art.

The present invention may also be more easily and cost effectively manufactured than prior art systems currently in use.

These and other objects and advantages of the invention will be apparent to those of skill in the van loading and transport arts.

### PRIOR ART PATENTS AND DESIGNS

The following U.S. Patents show fold-out types of designs which have utility for loading trucks:

Pat. No. 8,398,357 shows a parcel delivery crane or lift which does not teach the slide-out methodology of the present invention,
Pat. No. 7,713,019 shows loading for a flat-bed truck which also uses a fold-out crane and does not teach the slide-out system of the present invention.

Building construction cranes use a pivoting and rotating design and method which is not generally related to the present slide-out design.

Tow truck types of cranes or lifts use a winch type of system and not the tube slide-out design of the present invention.

It is thus believed that the combination van and slide-out design described herein is novel and patentable over all known prior art designs currently known to those of skill in the lifting and loading arts.

### SUMMARY OF THE INVENTION

A plurality of generally U-shaped support elements 21-23 are placed in a transport van of large or smaller size.

At the top center each support is a tube 30 having a slot formed in the bottom thereof.

Inside the tube 30 is another tube 40 which has a hoist 44 mounted thereon.

The inner tube 40 operates in a slide-out fashion so that it can be pushed far enough outside the van so that the hoist 44 can be used to pick up a load.

A load is then picked up and moved into the van by means of an electronic actuator.

The simpler slide-out design and method thus proves to be more effective for van usage as compared to the more complex fold-out or rotating crane designs and methods of use.

Thus, a more effective crane or lift specifically for van usage is presented.

### BRIEF DESCRIPTION OF THE DRAWING FIGURES

FIG. 1 is a rear schematic view of a van 10 having a crane or lift installed therein. The lift is placed at the top of a support 21 and includes a slidable tube 40 within an outer tube 30. The outer tube 30 includes a slot in the bottom thereof to allow a hoist to pass therethrough.

FIG. 2 is a side schematic view of the van 10 and showing the plural supports 22 and 23 and arrows indicating motion of the inner slidable tube 40 via the electric actuator EA and motion of the hoist 44 to pick up a load L.

FIG. 3 shows the method steps utilized generally in practice of the invention.

### FULL DESCRIPTION OF A PREFERRED EMBODIMENT

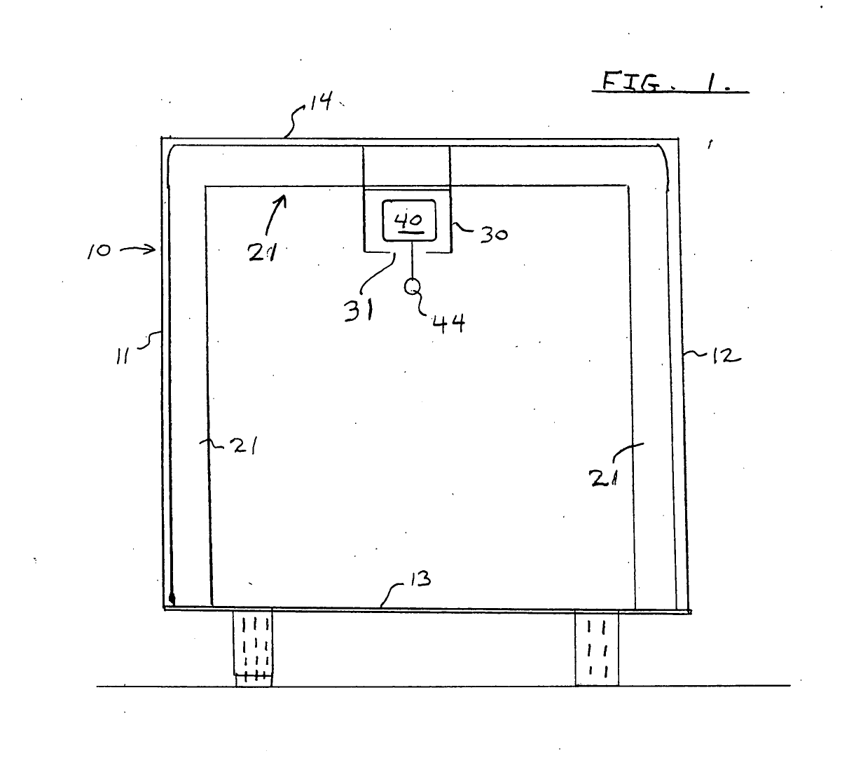

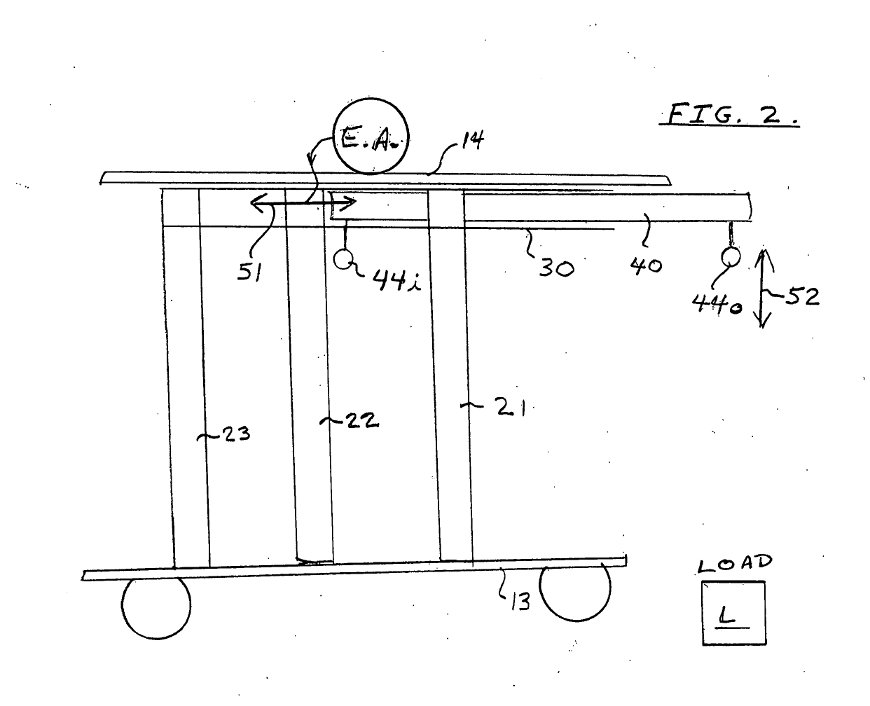

Referring to the drawing FIGS. 1 and 2, FIG. 1 shows a rear schematic view of a van 10 which may be of a larger or smaller size such as a package transport or a taxi-cab etc. The van 10 has side walls 11 and 12 and bottom and top walls 13 and 14 as shown.

The van includes a first support element 21 extending around the walls 11, 14 and 12 as shown.

At the top of the support unit 21 is a first tube element 30 having a slot 31 formed in the bottom portion thereof.

Inside the first tube 30 is a second tube 40 having a hoist unit 44 mounted thereon.

The second tube and hoist combination is moved in and out of the van 10 to lift or deposit a load as will be further described.

Such is accomplished via an electric actuator to be further shown and described.

Referring to the drawing FIG. 2 showing a side schematic view of the system and method, the first support 21 is again shown.

Further support units 22 and 23 are also shown in FIG. 2 and are of the same general shape as the support 21.

As further shown schematically in FIG. 2, the inner tube 40 is movable from an inner position to an outer position so that the hoist is outside the van as shown at 44o or inside the van as shown at 44i.

Arrows 51 indicate the movement of tube 40 to inner and outer positions via an electric actuator as indicated by the letters EA.

Arrows 52 indicate movement of the hoist unit 44 to an upper or lower position to pick up or deposit a load L.

Such hoist operation is of a type utilized in the crane arts but not heretofore known in this particular van loading operation.

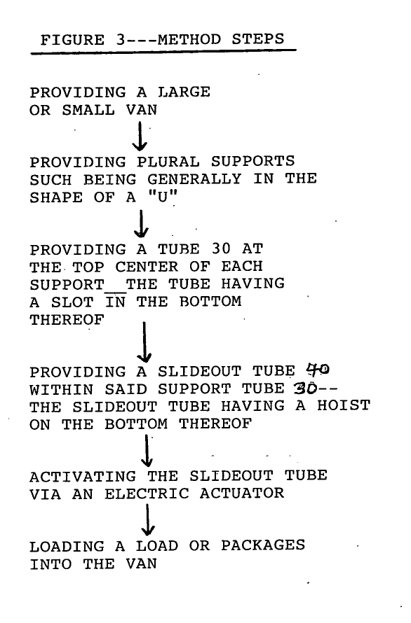

FIG. 3 shows the important and critical method steps utilized in practice of the invention.

The method steps are generally as follows:
provide a large or small van which is used to transport at least some loads or packages such as in a delivery van or a taxi-cab,
provide plural supports 21, 22 etc. of a shape and configuration as shown herein,
providing a slotted tube 30 at the top of each support unit,
providing a slide-out tube 40 within the support tube 30 wherein the slide-out tube has a hoist unit mounted thereon for picking up a load L,
providing that the slide-out tube is movable inwardly and outwardly via an electric actuator EA and that the hoist is movable up and down.

Such steps may vary as indicated by the method claims included herein.

The tube-within-a-tube design in combination with plural supports 21, 22 etc. and a hoist on the inner tube 40 is submitted to be patentable in its own rite as a truly novel crane or lift design. The specific combination into a van-type vehicle is believed to be even more advantageous in the loading arts.

The outer tube 30 is shown as a single tube in FIG. 2. It may be constructed as plural tubes each associated with supports etc. depending on choice of the crane purchaser and/or installer.

While a particular lift or crane system and method of use has been shown and described, it is intended in this specification to broadly cover all equivalent systems and methods which would reasonably occur to one of skill in the art. The invention is further defined by the claims attached hereto.

I claim:

1. A slide-out and lift means for use in combination with a van having inner walls comprising the following elements,
at least one support element conforming to the inner walls of the van,
wherein the top of said support has a first tube formed therein with a slot formed in the bottom of said first tube,
wherein a second tube means is positioned within said first tube and said second tube means has a hoist mounted thereon.

2. The system of claim 1 and further including added support units within the system, such being similar to said first support unit.

3. The system of claim 1 wherein the system is specifically in combination with a large or small van for transporting packages or other items or specifically in combination with a taxi-cab vehicle.

4. A method of loading and unloading a van type of vehicle comprising the steps of:
A) providing a large or small van having a rear compartment for containing packages,
B) placing plural U-shaped supports in the van transport area,
C) providing that each of said U-shaped supports has a tube positioned at a top portion thereof, each of said tubes having a slot formed in the bottom thereof,
D) wherein each of said tubes has a slidable tube mounted therein,
E) providing that the slidable tube has a hoist mounted on a lower portion thereof,
F) moving the slidable tube to a van outer position by means of an electronic actuator,
G) lowering and raising a hoist to pick up a load L,
H) moving the slidable tube back into the van and lowering the hoist to deposit the load into the van transport area.
